(19) United States
(12) Patent Application Publication
(10) Pub. No.: US 2016/0306811 A1
(43) Pub. Date: Oct. 20, 2016

(54) METHOD AND SYSTEM FOR CREATING INVERTED INDEX FILE OF VIDEO RESOURCE

(71) Applicants: Le Holdings (Beijing) Co., Ltd., Beijing (CN); LeCloud Computing Co., Ltd., Beijing (CN)

(72) Inventors: Kunbo Cao, Beijing (CN); Lei Zheng, Beijing (CN)

(21) Appl. No.: 15/101,698

(22) PCT Filed: Dec. 5, 2014
(86) PCT No.: PCT/CN2014/093176

§ 371 Date: Jun. 3, 2016

(30) Foreign Application Priority Data
Dec. 26, 2013 (CN) 201310733513.9
Dec. 26, 2013 (CN) 201310739955.4
Dec. 26, 2013 (CN) 201310739976.6
Dec. 26, 2013 (CN) 201310740121.5
Dec. 26, 2013 (CN) 201310740122.X
Dec. 26, 2013 (CN) 201310740124.9
Dec. 26, 2013 (CN) 201310740723.0
Dec. 26, 2013 (CN) 201310741040.7
Dec. 26, 2013 (CN) 201310741178.7

(51) Int. Cl. G06F 17/30

(52) U.S. Cl. CPC G06F 17/3082; G06F 17/30858; G06F 17/3084

(57) ABSTRACT

The present invention provides a method and a system for creating an inverted index file of a video resource. The method comprises: performing word segmentation processing on video file information in a preset word segmentation manner, to obtain a keyword; establishing an index relationship between the keyword and the video file information having the keyword, to create an inverted index file of a video file. According to the present invention, word segmentation processing is performed on video file information to obtain a keyword, and an index relationship between the keyword and the video file information having the keyword is established, to create an inverted index file; and when a user searches for a video file by using the keyword, corresponding information can be rapidly and accurately provided.

This application claims the benefits of the following Chinese Patent Applications filed with the State Intellectual Property Office of People's Republic of China on Dec. 26, 2013, all of which are hereby incorporated by reference in their entireties: No. 201310740723.0, entitled “Method and system for vertical search of a video website”; No. 201310739955.4, entitled “Method and system for creating an inverted index file of video resources”; No. 201310741040.7, entitled “Method and system for managing a lexicon of video resources”; No. 201310739976.6, entitled “Method and system for sorting information about video resources”; No. 201310741178.7, entitled “Method and system for storing inverted indexes”; No. 201310740121.5, entitled “Method and system for distributed indexing of video data”; No. 201310733513.9, entitled “Method and system for processing data sources of video resources”; No. 201310740122.X, entitled “Method and system of data adaption for video data”; and No. 201310740124.9, entitled “Method and system for adapting video data resources”.

### FIELD

The present disclosure relates to the field of information retrieval and particularly to a method and system for creating an inverted index file of video resources.

### BACKGROUND

More and more users search for and watch various videos over the Internet along with the development of sciences and technologies. Since video information available from the Internet is diverse and the video information is constantly changing and updated, a number of search engines have emerged therewith to search for the video information.

In a relational database system, indexes are the most efficient way to search for data. However the engines to search for videos throughout the Internet have not been satisfactory:

(1) The search engines search in massive video data throughout the Internet, the webpages to be indexed by search engines on the large video websites such as Le.com are hundreds of millions and even hundreds of billions, so it may be difficult to manage effectively the database system including such massive video data.

(2) Data manipulation used by the search engines are simple, and generally only the several functions of adding, deleting, modifying, searching, etc., are necessary. Moreover the data are in specific formats, so simple and efficient application program can be designed for these applications. Normal database systems support large and comprehensive functions at the cost of their speeds and spaces.

(3) The search engines deal with a large number of user search requests, so computation extensive tasks have to be performed as many as possible while the indexes are being created to thereby minimize an effort of search computation. It may be difficult for the normal database systems to support such a large number of user requests, and the normal database systems may not be satisfactory in terms of a search response time and search concurrency.

In summary, there is such a technical problem in the prior art that the solutions to data indexes of massive video information may not be satisfactory in terms of the amount of data, the response time, the efficiency, etc, and thus there is a need to propose improved technical solution to address the above problems.

### SUMMARY

In view of this, the disclosure provides a method and system for creating an inverted index file of video resources so as to address the problem in the prior art of a slow and inefficient search in massive data.

Particularly the disclosure is embodied as the following technical solutions:

A first aspect provides a method for creating an inverted index file of video resources, the method including:

obtaining keywords by performing word segmentation on video file information in a preset segmentation scheme; and

creating an index relationship between the keywords and the video file information including the keywords to create an inverted index file of the video files.

A second aspect provides a system for creating an inverted index file of video resources, the system including:

a keyword obtaining module configured to obtain keywords by performing word segmentation on video file information in a preset segmentation scheme; and

an inverted index creating module configured to create an index relationship between the keywords and the video file information including the keywords to create an inverted index file of the video files.

With the technical solutions according to the embodiment of the disclosure, the video file information is segmented into the keywords, and the index relationship between the keywords and the video file information including the keywords is created to thereby create the inverted index file of the video files, so that if a user searches for a video file using a keyword, the corresponding information can be provided rapidly and accurately.

### BRIEF DESCRIPTION OF THE DRAWINGS

FIG. 1 is a schematic flow chart of a method for creating an inverted index file of video resources according to an embodiment of the disclosure;

FIG. 2 is a flow chart of a method for managing a lexicon according to an embodiment of the disclosure;

FIG. 3 is a flow chart of a method for obtaining word information searched by a user as the video resource lexicon according to an embodiment of the disclosure;

FIG. 4 is a flow chart of a method for processing video resource data sources according to an embodiment of the disclosure;

FIG. 5 is a flow chart of vertical search of a video website according to an embodiment of the disclosure;

FIG. 6 is a flow chart of a method of sorting video resource information according to an embodiment of the disclosure;

FIG. 7 is a flow chart of a method of data adaption for video data according to an embodiment of the disclosure;

FIG. 8 is a flow chart of a method adapting video data resources according to an embodiment of the disclosure;

FIG. 9 is a flow chart of a method for storing inverted indexes according to an embodiment of the disclosure;

FIG. 10 is a flow chart of a method for distributed indexing of video data according to an embodiment of the disclosure;

FIG. 11 is a flow chart of a method for distributed indexing of video data according to another embodiment of the disclosure;

FIG. 12 is a system for creating an inverted index file of video resources according to an embodiment of the disclosure;

FIG. 13 is a system for creating an inverted index file of video resources according to another embodiment of the disclosure;

FIG. 14 is a system for creating an inverted index file of video resources according to a further embodiment of the disclosure;

FIG. 15 is a system for creating an inverted index file of video resources according to a further embodiment of the disclosure;

FIG. 16 is a system for creating an inverted index file of video resources according to a further embodiment of the disclosure;

FIG. 17 is a system for creating an inverted index file of video resources according to a further embodiment of the disclosure; and

FIG. 18 is a system for creating an inverted index file of video resources according to a further embodiment of the disclosure.

### DETAILED DESCRIPTION OF THE EMBODIMENTS

Normal indexing, i.e., forward indexing, determines attribute values from records and inverted indexing determines positions of records by attribute values, which is referred to as inverted indexing. The disclosure is provided for store and search for video resources of a video website hosting the massive video resources by creating inverted indexes from characters (words) to documents for files throughout the website (video files over the Internet) so that if a user searches using a keyword for a document (webpage), the system will return a document (webpage) including the keyword to the user.

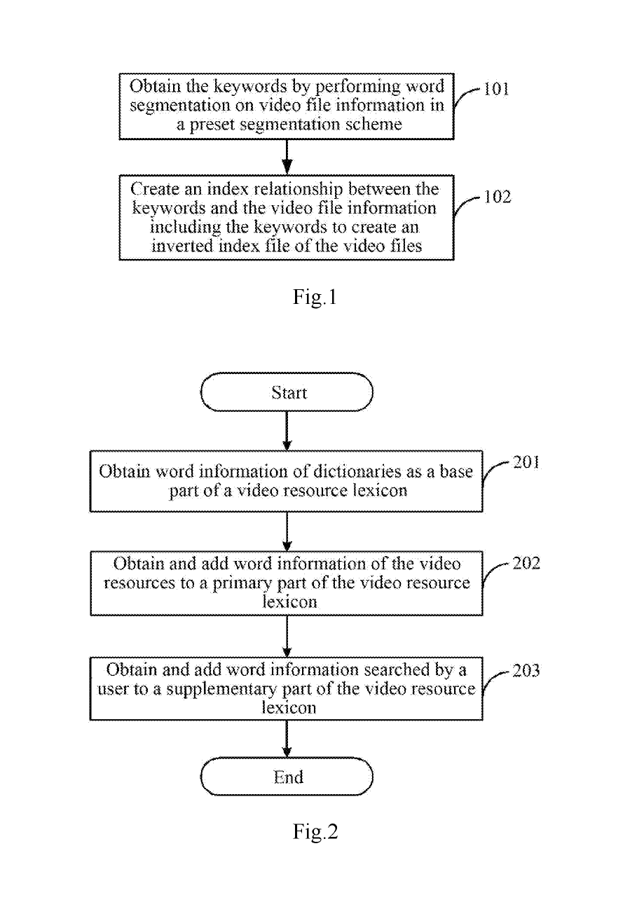

An embodiment of the disclosure provides a method for creating an inverted index file of video resources. Referring to FIG. 1 which is a schematic flow chart of a method for creating an inverted index file of video resources according to an embodiment of the disclosure, the method can include the following operations:

The operation 101 is to obtain keywords by performing word segmentation process on video file information in a preset segmentation scheme.

The operation 102 is to create an index relationship between the keywords and the video file information including the keywords to create an inverted index file of the video files.

Particularly in the operation 101, the video file information refers to name, subjects, summaries, and other text information, of the video files, and the keywords of the video file information can be obtained by word segmentation. The video file information is generally segmented by recombining as specified a consecutive sequence of characters into another sequence of words for the purpose of analyzing the respective documents for extracting those (characters) words likely to be search objects of a user.

The word segmentation can be generally categorized into word segmentation in Chinese and segmentation in a foreign language (for example, English hereinafter) according to different languages of video file information. In English, the space is an obvious delimiter by which words can be spaced, and some redundant words (e.g., “a”, “the”, etc.) are further removed, so that the word segmentation can be completed, as exemplified below:

For example, if there are two files 1 and 2, where the contents of the file 1 are “Tom lives in Guangzhou, I live in Guangzhou, too”, then the keywords of file 1 after word segmentation can include [tom] [live] [guangzhou] [i] [live] [guangzhou].

The contents of the file 2 are “He once lived in Shanghai.” The keywords of file 2 after word segmentation can include [he] [live] [shanghai].

Segmentation in Chinese is more complex than segmentation in English in that there is no obvious delimiter between words in Chinese. Moreover in view of the complexity of the Chinese language, in order to address the ambiguity occurring in segmentation, some segmentation algorithm will be further applied, e.g., binary word segmentation, maximum matching, statistics, etc., to segment the video file information. In binary word segmentation, a name is split at the step of 2 so that the name with a length of n (n characters) is split into (n-1) binary words, where there is a shared Chinese character in the preceding word and the succeeding word. Maximum matching includes forward maximum matching and backward maximum matching, although a repeated description thereof will be omitted here.

Preferably after the video file information is segmented into the words through binary word segmentation, maximum matching, statistics, etc., the words into which the video file information is segmented are verified in a lexicon to determine whether the words into which the video file information is segmented are correct.

In the operation 102, after the video file information is segmented into the keywords, the keywords are stored in the inverted index file together with the identification information (ID) of the corresponding files, and after all the files are analyzed, the keywords are sorted, merged, etc., in an order of the keywords being obtained, the probabilities that the respective keywords occur in the files are counted, and the index file may further include other index information. For example, the number of files indicates the number of files in which a keyword occurs; a total frequency indicates that the number of times that the keyword occurs in the respective files; and a frequency indicates the number of times that the keyword occurs in one file. Thus the keywords are associated with the index information thereof.

Further to the example above, Table 1 depicts the keywords and their corresponding index information, that is, the keywords and their corresponding “frequency of occurrence ” and “position of occurrence” are included in the final index structure.

TABLE 1

| | File No. [Frequency of | |
|---|---|---|
| Keyword | occurrence] | Position of occurrence |
| guangzhou | 1[2] | 3, 6 |
| he | 2[1] | 1 |
| i | 1[1] | 4 |
| Live | 1[2], 2[1] | 2, 5, 2 |
| shanghai | 2[1] | 3 |
| tom | 1[1] | 1 |

According to the embodiment above, after the inverted index file is created, the user inputs a query condition, the inverted index file is scanned for a set of candidate files, and the video files are output as required, to thereby retrieve rapidly and precisely the video resources so as to satisfy the requirement of storage of and search in the massive video resources.

In a real application, searching for a video resource is characterized by suddenness, and if some hot video (e.g., a movie, a teleplay, an entertainment show, etc.) is showed or some focus event (e.g., a news event) occurs, then there may be a large number of search requests made in a short period of time, and in this case, search results obtained from the inverted index file are counted, and the keywords with the search frequencies above a preset threshold are adjusted to the file head of the inverted index file to thereby improve the search efficiency.

In summary, in the technical solution according to the embodiment of the disclosure, the video file information is segmented into the keywords, and the index relationship between the keywords and the video file information including the keywords is created to thereby create the inverted index file, and when the user searches for a video file using a keyword, the corresponding information can be provided rapidly and accurately.

Further, in order to perform segmentation in the operation 101, the lexicon is further provided so that segmentation is performed according to the lexicon. In the vertical search engine of the video website, the lexicon plays a significant role, and inverted indexing above is important indexing applicable to the search engine in that inverted indexing addresses storage of and search in the massive video resources, that is, the search engine would not operate well without the good lexicon. A lot of video related word data are stored in the video resource lexicon so that these word data stored in the lexicon are invoked by the search engine. If a word in the lexicon occurs in a match object, then the word will be separated from the match object, which can be referred to as word segmentation. The search efficiency can be improved using the lexicon due to the characteristic of the search in the video information. The lexicon in the embodiment of the disclosure will be described below in details.

Particularly in an embodiment of the disclosure, the words are stored in the video resource lexicon together with parts of speech information of the words, where the parts of speech of the words can be set according to sources of the video resources, e.g., general words or albums or user uploaded videos, although the embodiment of the disclosure will not be limited thereto. Here the album refers to copyrighted video resources; and the user uploaded videos refer to User Generated Contents (UGCs). Moreover the words can be provided with weight information about the weights of the words, which are calculated according to some algorithm.

FIG. 2 is a flow chart of a method for managing a lexicon according to an embodiment of the disclosure, which is applicable to generation and management of the lexicon used in word segmentation above, and as illustrated in FIG. 2, the method includes the following operations:

The operation 201 is to obtain word information of dictionaries as a base part of a video resource lexicon;

Frequently used words are stored in the dictionaries (lexicons), and in the embodiment of the disclosure, words in various dictionaries are taken as the base part of the video resource lexicon, and constitute the video resource lexicon together with other words (words of the video resources, user generated contents, etc.).

The operation 202 is to obtain and add word information of the video resources to a primary part of the video resource lexicon;

Information about the video resources stored in a preset video resource library is retrieved, and the word information therein is extracted and added to the video resource lexicon. There are a large number of video resources stored in the video resource library, e.g., films and teleplays, entertainment shows, etc. Titles, directors, actors, summaries, contents, and other word information of these video resources are one of primary sources of the words in the lexicon, and words related to the video resources are primary part of the video resource lexicon.

In a real application, the video resource library can include local video resource data that have copyright, or video resource data available from a cooperator, or information available from video resource data obtained otherwise.

The operation 203 is to obtain and add word information searched by a user to a supplementary part of the video resource lexicon.

Word information input by a searching user is obtained, and if the word information input by the user is absent in the current video resource lexicon, that is, the word input by the user is a new word, then in this case, the word information input by the user will be added to the video resource lexicon. Preferably if there is no word information, in the current video resource lexicon, corresponding to the word information input by the user, then the word information input by the user, and the frequency it is input will be accumulated, and if the frequency of the of the same word information being input by the user exceeds a preset threshold, then the word information input by the user will be added to the video resource lexicon, and the word information input by the searching user will be a supplementary part of the video resource lexicon.

In summary, the video resource lexicon according to the disclosure generally includes the base part, the primary part, and the supplementary part, and the different parts of the video resource lexicon include the words with the corresponding parts of speech.

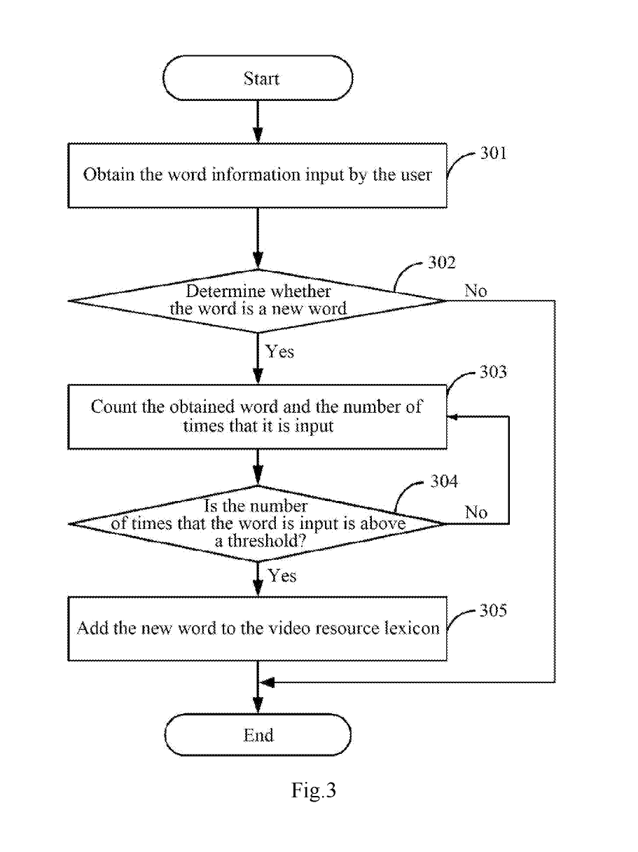

Referring to FIG. 3 which is a flow chart of a method for obtaining the word information input by the searching user as the video resource lexicon according to an embodiment of the disclosure, the method includes the following operations:

The operation 301 is to obtain the word information input by the searching user. If the user searching the video website for a video resource inputs a search keyword, then the word information input by the user can be taken in some way to thereby obtain the word information input by the user. The word information input by the user in the disclosure is defined as the User Generated Contents (UGCs).

The operation 302 is to determine whether there is word information, in the current video resource lexicon, corresponding to the word information input by the user, that is, to determine whether the word is a new word, and if so, to proceed to operation 303; otherwise, that is, there is corresponding information in the current video resource lexicon, the flow ends.

In the operation 303, if the word input by the user is a new word, then the word information and the number of times that it is input is counted. In a real application, a new word will not be added immediately to the video resource lexicon once it is detected. In an embodiment, if a new word is input for the first time, then the number of times when the new word occurs will be counted, and it will be added to the video resource lexicon only if the number of times when it is input is above a threshold.

The operation 304 is to determine whether the counted number of times that the new word is input is above a preset threshold, and if so, to proceed to operation 305; otherwise, to return to operation 303 where the number of times when the new word occurs is counted.

The operation 305 is to add the new word to the video resource lexicon. The flow ends.

In the technical solution according to the embodiment of the disclosure, the video resource lexicon is created by obtaining the words of the dictionary, the words of the video resources, the words of the user searches, etc., respectively, so that the video resource lexicon will be highly integral and correct to thereby guarantee a high-quality search engine.

As described above, inverted indexing is significant indexing for the search engine, and in a real application, the search engine frequently operates with different data sources of video resources, where these data sources are diverse and have complicated origins, so if these data sources in various dimensions were not processed, then created inverted indexing would have been inefficient in searching and thus unsatisfactory to the search engine. In view of this, an embodiment of the disclosure provides a method for processing data sources of video resources, which can be performed to save the time taken to create inverted indexing.

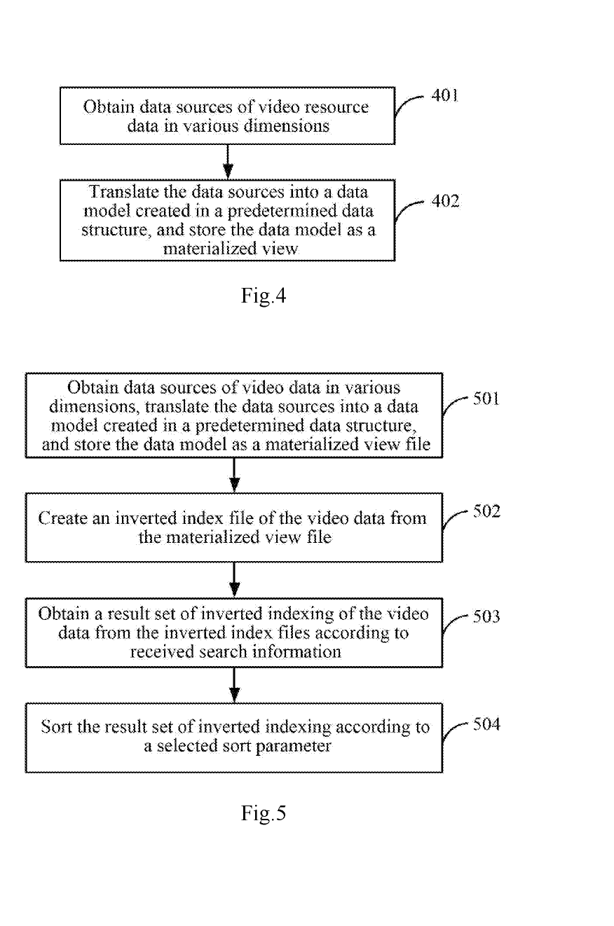

FIG. 4 is a flow chart of a method for processing data sources of video resources according to an embodiment of the disclosure, and as illustrated in FIG. 1, the method includes the following operations:

The operation 401 is to obtain data sources of video resource data in various dimensions.

The data sources refer to original data, and if the data sources of the video resource data are initially obtained or received, then the search engine will operate with the unprocessed data sources with service logic, but a data structure of inverted indexes can not be created directly from the data sources with the service logic.

In a real application, the obtained data sources of the video resource data in various dimensions can be divided differently, for example, the data sources may include file systems and databases (DBs) when categorized according to the sources of the video resource data; the data sources may include TV terminals and mobile terminals when categorized according to types of terminal to which video resource are applied; and the data sources may include extensible markup language (XML) files or text (TXT) files when categorized according to file formats of the video resources. Of course, the dimensions of the data sources will not be limited thereto, but other dimensions of the data sources can be defined.

The operation 402 is to translate the data sources into a data model created in a predetermined data structure, and to store the data model as a materialized view.

The materialized view is actually a materialized table, and since the data model is database based, the data model is stored as the materialized view so that the data model is stored in the form of the materialized table for subsequent invocation by the search engine for a query.

The data sources in various dimensions are differently characterized, and in order to shielding the complicated service logic of the in various dimensions, the data sources in various dimensions will be translated into the uniformly structured data model. The data model in the predetermined data structure includes base data and extended data.

Here the base data are underlying dimension data the most interesting to a search, which are data necessary to present videos (movies and teleplays), e.g., video titles, video summaries, actors (leading actors), directors, and other information. Generally the video data are provided with an offline application logic attribute, for example, the extended data are provided with a platform attribute; and moreover there are some further video data with a customized functional attribute, for example, the extended data include a platform price, code stream information, etc. It shall be noted that the examples above are merely illustrative but the disclosure will not be limited thereto.

In the database based data model, the base data and the extended data are stored in the predetermined data structure. Particularly the base data are fixed in length, and extended horizontally, and the respective data are stored one by one; and the extended data are variable in length, and stored in columns. This scheme in which the base data are stored in rows and the extended data are stored in columns is highly flexible.

Then the data model in the predetermined data structure is stored as the materialized view so that inverted indexing can be created simply by facing the materialized view of the uniform data model, and a search can be conducted using the materialized view to thereby avoid time-consuming operations so as to obtain rapidly a search result, thus greatly saving the time taken to create inverted indexing, for example, it will take only one or two minutes to conduct a rapid search in hundreds of millions of data entries.

In a real application, the materialized view in which the data model in the predetermined data structure is stored can be a basic view from which multiple views related to the data structure can be created so that inverted indexing can be crated from the multiple views. Thus a search can be conducted using extended parameters of the search to thereby obtain rapidly a search result.

With the data sources processed above, the data sources of the video resource data in various dimensions can be translated into the data model in the predetermined data structure, and the data model can be stored as the materialized view, so that inverted indexing can be created simply by facing the materialized view of the uniform data model, and a search can be conducted to obtain rapidly a search result, thus greatly saving the time taken to create inverted indexing.

Still furthermore, after the data sources are processed above to obtain the materialized view file, the materialized view file is segmented into keywords in a preset segmentation scheme, and an inverted index file is created; and moreover in the embodiment of the disclosure, after the inverted index file is created, a result set of inverted indexing can be sorted according to sort parameters to thereby provide a method for vertical search of a video website so as to realize the vertical search of video resources, thus improving in effect the efficiency of searching for a video resource. Particularly referring to FIG. 5 which is a flow chart of a method for vertical search of a video website according to an embodiment of the disclosure, the method includes the following operations:

The operation 501 is to obtain data sources of video data in various dimensions, to translate the data sources into a data model created in a predetermined data structure, and to store the data model as a materialized view file;

The operation 502 is to create an inverted index file of the video data from the materialized view file;

The data structure in agreement with a search construct can be created according to the data model matching with the data sources in various dimensions to thereby create an inverted index file of video files. Particularly the materialized view file is segmented into keywords in a preset segmentation scheme, and an index relationship between the keyword and the materialized view file including the keywords, to thereby create the inverted index file of the video data.

The operation 503 is to obtain a result set of inverted indexing of the video data from the inverted index files according to received search information;

A search engine for the outside (a user) is provided to receive search information for video resource information, to match the search information within the inverted index file, to reverse the indexing results according to the data, in the inverted index file, matching with the search information, and to output the result set of inverted indexing including pieces of video information.

Here source channels of the data sources include video databases (DBs), extensible markup language (xml) files, file systems, etc.

The operation 504 is to sort the result sets of inverted indexing according to a selected sort parameter.

With the embodiment above, for the massive video search information, the result sets can be narrowed by reversing the indexes, and the demand for sorting can be satisfied by forward sorting, to thereby improve the search efficiency and the experience of the user.

Here for details about translation of the data sources into the data model and storage of the data model as the materialized view in the operation 501, reference can be made to the corresponding description of the embodiment in FIG. 4, so a repeated description thereof will be omitted here. For details about creation of the inverted index file in the operation 502, reference can be made to the embodiment above, where the materialized view file is segmented to obtain preliminary segmented words in the preset segmentation scheme; the preliminary segmented words are adjusted to the keywords according to the lexicon, and particularly the lexicon can be searched for the preliminary segmented words, and if the preliminary segmented words are found, then it can be determined that preliminary segmentation is correct, and the preliminary segmented words can be determined as the keywords, and if the preliminary segmented words are not found, then it can be determined that preliminary segmentation is incorrect, and preliminary segmentation can be further performed in the preset segmentation scheme; and the index relationship between the keywords and the video file information including the keywords to thereby create the inverted index file of the video resources.

Here in the operation 504 above, the result sets of inverted indexing is sorted according to the selected sort parameter by providing sort parameter information, receiving the sort parameter selected by the user, and sorting the result sets of inverted indexing according to the received sort parameter. Particularly in a real application, interaction can be conducted with the user via a user interface to provide the parameter information for sorting and to receive the sort parameter selected by the user. The sort parameter information includes but will not be limited to show time, play duration, and video file related information, where the show time, referred to as issuance time, represents time information about the year/month/date when the video information is initially shown or issued, etc.; the play duration represents information about the temporal length of the video information; and the video file related information represents information dependent upon the characteristic of the video file, including the serial number, the album number, the video contents, the names of persons appearing in the video, and other further detailed information, for an album.

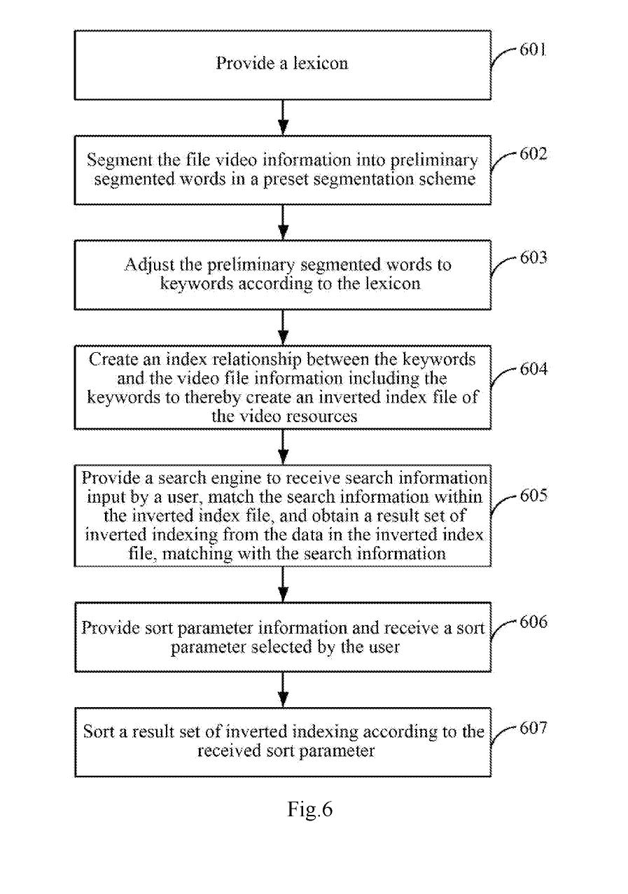

FIG. 6 is a flow chart of a preferred process of the method for sorting the video resource information according to an embodiment of the disclosure, and as illustrated in FIG. 6, the process includes the following operations:

The operation 601 is to provide a lexicon, data sources of which include but will not be limited to a base lexicon, a video copyright lexicon, and User Generated Contents (UGCs).

Here the base lexicon includes various dictionaries and lexicons, and since video files may not be strictly consistent with entries in the dictionaries, the video copyright lexicon may be necessary. The video copyright lexicon is a lexicon obtained according to copyrighted video resource information, and the lexicon can satisfy the requirement of word segmentation of video file information. The UGCs are contents generated or provided or authorized by users to provide some new words absent in the base lexicon and the video copyright lexicon. The respective lexicons supplement and cooperate with each other so that the video resource information can be segmented into ideal keywords.

The operation 602 is to perform word segmentation on the file video information to obtain preliminary segmented words in a preset segmentation scheme, where the preset segmentation scheme includes binary word segmentation, maximum matching, statistics, etc., a repeated description of which will be omitted here.

The operation 603 is to adjust the preliminary segmented words to keywords according to the lexicon.

In this operation, the lexicon can be searched for the preliminary segmented words obtained in the operation 602, and if the segmented words are found, then it can be determined that preliminary segmentation is correct, and the preliminary segmented words can be determined as the keywords; and if the preliminary segmented words are not found, then it can be determined that preliminary segmentation is incorrect, and preliminary segmentation can be further performed in the preset segmentation scheme.

The operation 604 is to create an index relationship between the keywords and the video file information including the keywords to thereby create an inverted index file of the video resources.

The operation 605 is to provide a search engine to receive search information input by a user for video resource information, to match the search information within the inverted index file, and to obtain a result set of reversed indexing from the data in the inverted index file, matching with the search information.

For example, the user inputs a search term “Chinese Good Voice”, and the entire website is searched for video files about “Chinese Good Voice” according to the inverted index file to retrieve a number of related video files.

The operation 606 is to provide sort parameter information and to receive a sort parameter selected by the user.

With the example above, since there are a very large number of video files about “Chinese Good Voice” in the network, results of the initial search may not be satisfactory. In the embodiment of the disclosure, a variety of sort parameter information is provided, and a parameter is selected by the user as desirable to him or her for further sorting. In a real application, the sort parameter information includes but will not be limited to show time, play duration, a serial number, the names of mentors, the names of students, and other video file related information.

The operation 607 is to sort result sets of inverted indexing according to the received sort parameter.

According to the embodiment above, the result sets of inverted indexing of the video files is obtained, and sorted according to the received sort parameter, so that despite the massive video search information, the result sets can be narrowed by inverted indexing and further narrowed by further forward indexing to thereby satisfy the demand for sorting so as to improve the search efficiency and the experience of the user.

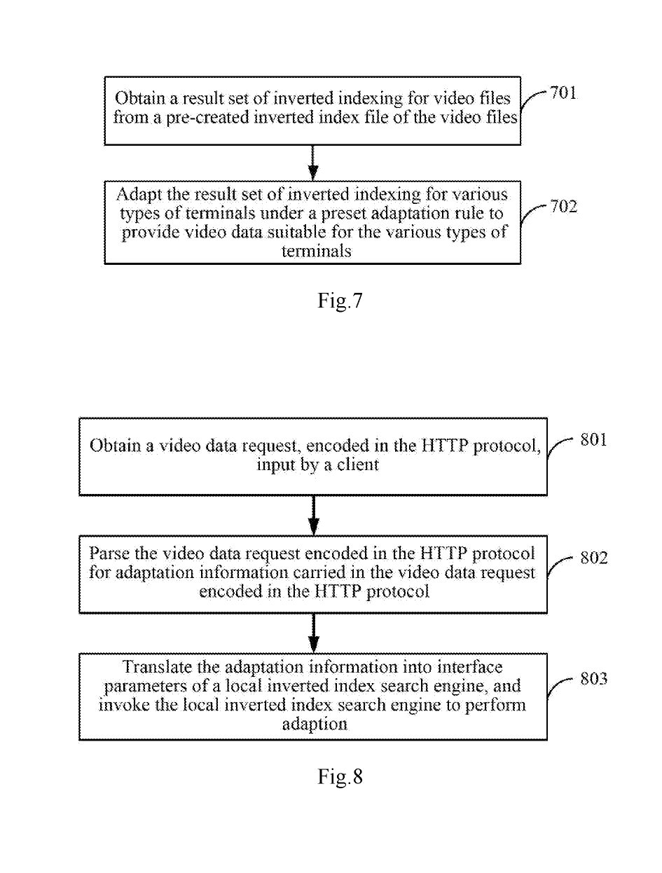

In anther embodiment, after the result set of inverted indexing for the video files is obtained from the inverted index file, the video data corresponding to the result set will be provided to an end device, but the types of end devices have become further diversified as the users are currently watching video programs online on their handsets and other mobile devices, smart TV sets, or other devices, so it would not have been satisfactory if the various types of end devices were provided only with a single type of data service, and the base data will be processed to satisfy the different types of terminals (or users). In view of this, after the inverted index file is obtained in the embodiment of the disclosure, a flow chart of a method of data adaption for video data according to an embodiment of the disclosure as illustrated in FIG. 7 can be further performed, and as illustrated in FIG. 7, the method includes the following operations:

The operation 701 is to obtain a result set of reversed indexing for video files from a pre-created inverted index file of the video files, particularly as described in the embodiment above, a repeated description of which will be limited here.

The operation 702 is to adapt the result set of inverted indexing for various types of terminals under a preset adaptation rule to provide video data suitable for the various types of terminals.

Particularly the obtained result set of reversed indexing includes uniformly formatted base data, and if the base data were not adapted, then the base data could not be provided directly to a user for use. Before the operation S104 is performed, the adaptation rule will be preset, where there are different adaptation rules for the video data of the different types of terminals. In the embodiment of the disclosure, the different types of terminals include TV sets (smart TV sets), mobile terminals, computers, etc. The mobile terminals can be further categorized into handsets and PADs.

Firstly data formats of the video data played on these different types of end devices are different, and there are some other constraints on the video data being played on these different types of end devices, e.g., copyright, data traffic, a platform, etc. An adaptation relationship between the parameters of the terminals and the data in the result set of inverted indexing can be created according to the types of the terminals, as detailed below.

For the same video data resource, it is copyrighted separately for the different types of terminals. Particularly the video data resource can be copyrighted separately for TV sets, mobile terminals (handsets and PADs), computers, etc. Only if the copyrights for all the types of end devices are available, then the video data of all the types of end devices can be available; and if there is no copyright for certain type of end device, then no video data of the type of end device will be available.

Moreover there are also different constraints for the different types of end devices on data traffic. A computer user typically accesses the Internet through a broadband link, so there will be no strict constraint on data traffic; and a handset user typically accesses the Internet in a 3G mode or the like, so the user will be sensitive to data traffic. Moreover there are also different fault tolerance constraints for the different types of end devices, so the video data will be adapted as described above for the types of terminals to satisfy the different users.

At present there are also different Internet Service Providers (ISPs) of some users, e.g., China Telecom and China Unicom. The video data can be adapted for these different ISP platforms to provide the user with different experiences.

According to the embodiment above, the base data are available from the obtained result set of inverted indexing of the video files, and can be adapted for the types of terminals to provide the video data suitable for the various types of terminals.

In a further embodiment, after the inverted index file of the video files is created, a video data request input by the user will be accepted, and the user will be provided with an access to the video resource data; and in a particular application, the user typically requests for a video resource using a keyword, but in a number of cases, the access request of the user to the video data resource is complicated, and may not be clearly expressed simply as a word or a parameter, for example, the user may request for the data concurrently using a keyword, a temporal range, a geographical area, a language, and other dimension information, or a combination thereof. Thus if the access request provided by the user can not be interpreted correctly or at all by a search engine, then a search service will not be offered properly, thus failing to better satisfy the user. In view of this, an embodiment of the disclosure further provides a method for adapting video data, and FIG. 8 is a flow chart of a method for adapting video data resources according to an embodiment of the disclosure. As illustrated in FIG. 8, the method includes:

The operation 801 is to obtain a video data request, encoded in the HTTP protocol, input by a client.

The client searching for a video data resource over the Internet sends the video data request to a server in the HTTP protocol. The HTTP stands for the Hyper Text Transfer Protocol, the data request can be sent to the server in the Get or Post mode, both of which are different modes in which data are transported in different organization formats and amounts of data. Simply Get is a request sent to the server for retrieving data, and Post is a request for submitting data to the server. Particularly the video data request input by the client can be a search request input in a webpage of a website, or can be a search request input by invoking an interface function available from the website.

The operation 802 is to parse the video data request encoded in the HTTP protocol for adaptation information carried in the video data request encoded in the HTTP protocol.

The obtained video data request encoded in the HTTP protocol can not be interpreted by a backend search engine, so the video data request encoded in the HTTP protocol can not be processed directly. The video data request encoded in the HTTP protocol will be translated in compliance with a local interface specification corresponding to the search engine, and parsed as required for interpretation by the reversed search engine, and then the video data request will be placed for the interpreted data.

For the HTTP request, the data of the request are appended to a URL (that is, the data are placed in an HTTP header), the URL is spaced from transmission data by “?”, and parameters are connected by “&”. If the data are English letters or digits, then they will be transmitted as they are; and if the data are the spacer, then they will be translated into “+”; and if the data are Chinese characters or other characters, then the string of characters will be BASE64 encoded directly, where “XX” in “% XX” represent the character represented in hexadecimal ASCII.

In a real implementation, since the header of the video data request encoded in the HTTP protocol is composed of a key-value pair, the key-value pair is parsed particularly as follows:

A user typically searches for a video data using a keyword, so the keyword is parsed as an important parse operation. The text information included in the video data request encoded in the HTTP protocol is matched absolutely or fuzzily with preset keywords, and if the matching succeeds, then the matching keyword is extracted as keyword adaptation information. For example, if the video data request is obtained in the Get mode as “http://ip/ . . . ?key=search&category= [symbol] ”, then the request is parsed for a keyword, thus resulting in keyword adaptation information of “ [symbol] ”.

A temporal range is important means to search for a video resource, and temporal information included in the video data request encoded in the HTTP protocol is parsed for temporal range adaptation information. For example, if the video data request is obtained in the Get mode as “http://ip/ . . . ?key=search&time=2012.01.01 [symbol] ”, then the request is parsed for a temporal range, thus resulting in temporal range adaptation information of “2012.01.01 [symbol] ”; and in another example, if the video data request is obtained in the Get mode as “http://ip/ . . . ?key=search&time= [symbol] 2013”, then the request is parsed for a temporal range, thus resulting in temporal range adaptation information of “ [symbol] 2013”.

Moreover parsing can further include regular expression parsing where information represented in a regular expression is parsed, prefix parsing where a URL link is parsed, and other parsing operations, although a repeated description thereof will be omitted here.

The operation 803 is to translate the adaptation information into interface parameters of a local inverted index search engine, and to invoke the local inverted index search engine to perform adaptation.

The identified adaptation information is translated into interface parameters of the local inverted search engine under a predetermined rule, and adapted by the local inverted search engine. Parameter information interpretable by the search engine can be obtained by the parsing process, and transmitted to the backend inverted index search engine, and then the inverted index search engine searches a pre-created inverted index file of video data resources using the parameter information, and obtains corresponding inverted indexing results.

The video data request, encoded in the HTTP protocol, input by the client is parsed for the parameter information carried in the video data request, encoded in the HTTP protocol, and the video data request, encoded in the HTTP protocol is translated into the parameters in compliance with the local search engine specification to thereby parse correctly the access request of the client to the video data resources and satisfy the users' requirements.

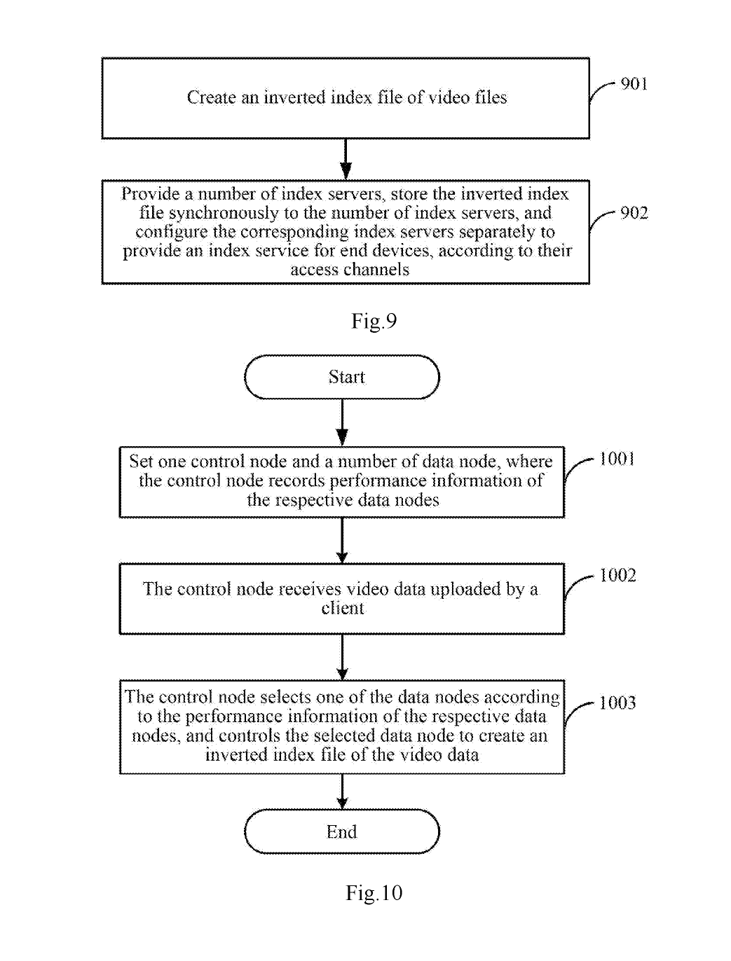

In a further embodiment, after the inverted index file of the video files is created, the inverted index file is stored into an index server, and the index server provides the end device with an index service. In a real application, the end device can access the Internet over a number of channels, and if the index service is provided as a uniform index service to all the end devices without taking into account the access channels of the end devices, then the search efficiency will be degraded, so an embodiment of the disclosure further provides a method of storing an inverted index file, and FIG. 9 is a flow chart of a method for storing an inverted index file according to an embodiment of the disclosure. As illustrated in FIG. 9, the method includes:

The operation 901 is to create an inverted index file of video files, particularly as described in the method described in the embodiment above, a repeated description of which will be omitted here.

The operation 902 is to provide a number of index servers, to store the inverted index file synchronously to the number of index servers, and to configure the corresponding index servers separately to provide an index service for end devices, according to their access channels.

The created inverted index file is stored synchronously to the number of external index servers, one or more of the index servers to provide the corresponding service are configured according to the access channels of the end devices, and more than one index server corresponding to a type of access channel are configured provide the index service in a distributed scheme.

In a particular implementation, after the inverted index file is stored synchronously to the number of external index servers, access channel information of the end device to which the index server provides the index service is set at each preset position of the inverted index file, so that if the end device initiate an access request, then it can be determined whether the current index server serves the end device initiating the access request, according to the access channel information set at the preset position of the inverted index file. Alternatively the order of keyword indexing results in the inverted index file is adjusted according to the different access channel of the end devices so that if the end device initiates an access request, then an indexing result highly associated with the type and channel of the end device will be given preferentially.

Since there are different channels of the respective accessing end devices, a differentiated service will be provided according to the characteristics of the end devices. Firstly the end devices are categorized as per type into mobile terminals, computers, smart TV sets, etc. Different data are required for these different types of end devices, and there are also different services desirable thereto. For example, fault-tolerance acceptable to a smart TV set is lowest, and fault-tolerance acceptable to a mobile terminal and a computer is higher. Several index servers to provide the smart TV terminal with an index service, several index servers to provide the mobile terminal with an index service, and several index servers to provide the computer terminal with an index service are configured separately. The index service can be provided separately according to the type of the end device to thereby improve the speed of the access request and the experience of a user.

Moreover the end device may access the Internet through an access service available from different operator platforms, and there is a low rate of data transmission between different operators (e.g., between China Telecom and China Unicom), which may be particularly obvious to a user accessing in a broadband mode. Index servers are configured separately for an access through the operator platforms to provide an index service separately so that a request of the user accessing across the different operation platforms can be processed rapidly to thereby improve the speed of the access request and improve the experience of the user.

With the embodiment above, upon reception of the access request of the end device to the inverted index file, the access channel of the end device is determined, and the corresponding index server is configured according to the access channel of the end device to provide the index service, so that the client can retrieve the inverted index information through the index server corresponding to the access channel thereof to thereby improve the efficiency and the speed of the access request.

In an embodiment of the disclosure, the index information needs to be updated from time to time, and a piece of newly index information may be inserted so that all the index information subsequent thereto will be moved backward in the inverted index file, so a cost of an I/O operation on a magnetic disk may be temporally increased for real-time updating. In the disclosure, a corresponding update mode is configured according to the access channel of the end device, and an updated inverted index file is distributed to the index servers corresponding to the access channels of the end devices in the configured update mode. For example, a periodicity-short or real-time update mode is configured for a smart TV set with low fault tolerance, and a periodicity-long update mode is configured for a computer or a mobile device with high fault tolerance. The inverted index file can be thus updated to thereby low an operating cost while satisfying the search user.

In a real application, if an event breaks out or a hot movie is showed, then there will be a burst increase of the number of accesses to these videos, and at this time, the burst accesses will be accommodated by extended servers. Particularly the number of access requests of the end devices is counted, and if the number of access requests to the same inverted index file exceeds preset threshold, then the extended index servers will be provided, and the corresponding inverted index file will be transmitted to the extended index servers so that an access request of the end device is received. These extended index servers and the previously normally operating servers provide a distributed index service.

Still furthermore the indexing technology is one of core technologies of the search engine, and the performance of the indexing technology imposes a direct influence upon the accuracy, and the response speed to the user, of the search engine, but there remains an interesting issue in a real application: a period of time taken for indexing increases linearly with the increasing number of indexed files, so that a search experience may be hindered by the creating of the indexes; and in a search engine application, there will be a performance bottleneck of the search engine if the number of indexed files reaches some level. At preset the video data can generally include albums (referred to as long videos) and User Generated Contents (UGCs). The UGC videos have the characteristics of large data information. Thus a lot of UGC video data will come with a significant increase of the number of indexed files, thus prolonging the period of time taken for indexing, so that there will be a performance bottleneck of the search engine. In view of this, an embodiment of the disclosure further provides a method for distributed indexing of video data, and FIG. 10 is a flow chart of a method for distributed indexing of video data according to an embodiment of the disclosure. As illustrated in FIG. 10, the method includes the following operations:

The operation 1001 is to set one control node and a number of data nodes, where the control node records performance information of each of the data nodes respectively.

The control node and the data nodes are set among server resources, and both the control node and the data nodes can function as a search engine, where the control node is connected respectively with each of the data nodes, and records various information about each of the data nodes, and the control node centrally controls each of the data nodes to perform data storage and data search; and each of the data nodes are controlled by the control node to perform distributed indexing.

In a real application, the control node can acquire performance information of each of the data nodes by sending a heartbeat packet to the respective data nodes, where the performance information includes but will not be limited to at least one of a data processing capacity, the amount of stored data, and load information.

In the operation 1002, the control node receives video data uploaded by a client.

The video data uploaded by the client is defined as User Generated Contents (UGCs). Since there are a very large amount of data of the video data uploaded by the client, there will be a significant increase of the number of indexed files, and if distributed indexing is performed on this type of video data, then the accuracy of a search can be improved, and a response to the user can be speeded up.

In the operation 1003, the control node selects one of the data nodes according to the performance information of the respective data nodes, and controls the selected data node to create an inverted index file of the video data.

If the control node receives the video data uploaded by the client, then the control node selects a data node with the highest current performance according to recorded performance indexes of the data nodes, and notifies the selected data node, and the selected data node is associated directly with the client, and creates the inverted index file of the video data.

It shall be noted that the control node can select the data node with the highest current performance according to one of the data processing capacities, the amounts of stored data, and the load information, of the data nodes, or a combination of these indexes, although the embodiment of the disclosure will not be limited thereto.

Then the selected data node stores locally the created inverted index file into an index library of the data node. In order to improve the security of the data, in an embodiment of the disclosure, the inverted index file is backed up, where the control node controls another data node to back up the inverted index file. Thus if the locally stored inverted index file is damaged or lost, then a search for data can be further performed using the backed-up inverted index file.

With the embodiment above, the video data are thus imported. Next a search can be made for video data.

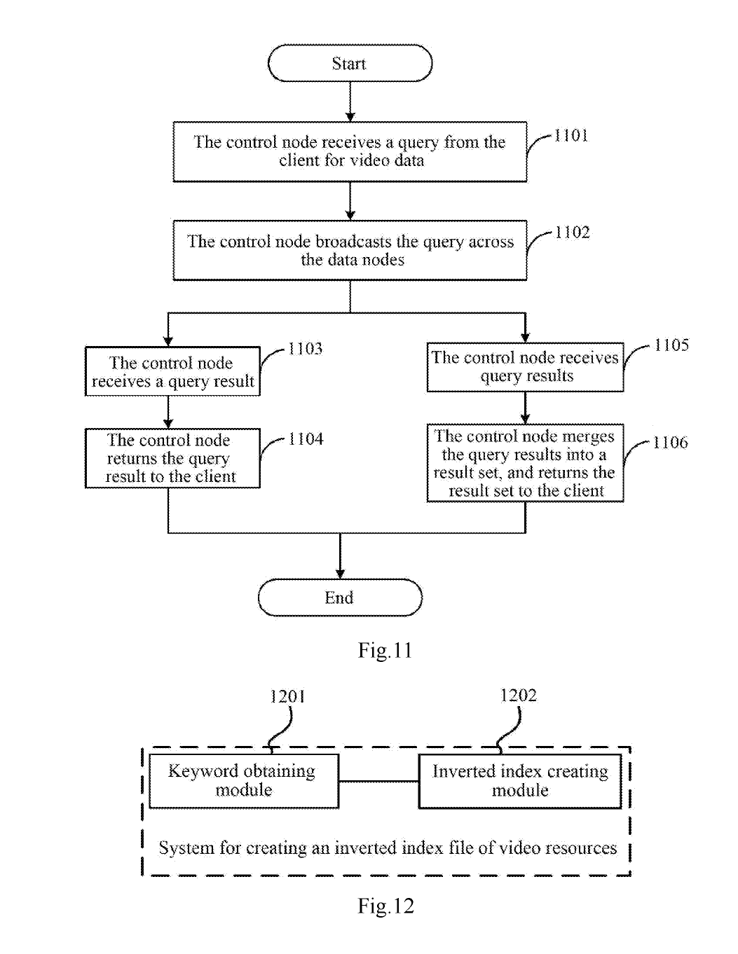

Referring below to FIG. 11 which is a flow chart of a method for distributed indexing of video data according to another embodiment of the disclosure, the method includes the following operations:

In the operation 1101, the control node receives a query from the client for video data.

In the operation 1102, the control node broadcasts the query across the data nodes.

The control node has no knowledge of which of the data nodes stores therein an inverted index file corresponding to the search information, so the control node distributes the query by broadcasting the query. The respective data nodes receiving the broadcast query search locally for the inverted index file corresponding to the query, and those data nodes founding the corresponding inverted index file return query results to the control node.

In the operation 1103, the control node receives a query result returned by the data nodes storing therein the inverted index file corresponding to the query.

In the operation 1104, the control node returns the query result to the client.

In the operations 1105 to 1106, in a real implementation, if the control node broadcasts the query across the data nodes, then since there are a very large amount of data of the video data, the control node will receive the query results returned by a number of data nodes, and in this case, the control node will merge the query results into a result set, and return the result set to the client.

With this solution, the control node receiving the video data uploaded by the client selects the data nodes to create the inverted index file, according to the performance information of the respective data nodes, so that the data nodes are controlled by the control node to perform distributed indexing of the video data to thereby improve the accuracy of the search and the efficiency of the search.

It shall be noted that in the method for creating an inverted index file of video resources according to the embodiments of the disclosure, a number of methods have been applied, and the respective methods can be combined with each other, for example, a complete lexicon to support the word segmentation is provided on the basis of the creation of the inverted index file; in another example, the created inverted index file can be further stored to a number of index servers to thereby improve the efficiency of a search; and in further example, result sets of search can be further obtained from the created inverted index file, and sorted to thereby improve the efficiency of a search, etc., as detailed in the flows of the respective embodiments of the methods above.

Furthermore in a particular implementation, the respective methods can alternatively be applied alone: for example, the lexicon above can be applicable to both a search engine of inverted indexing and another type of search engine to thereby guarantee a high-quality search engine, etc.

In order to put into practice the respective embodiments above of the disclosure, an embodiment of the disclosure further provides a system for creating an inverted index file of video resources, and referring to FIG. 12, the system can include a keyword obtaining module 1201 and an inverted index creating module 1202, where:

The keyword obtaining module 1201 is configured to obtain keywords by performing word segmentation process on video file information in a preset segmentation scheme; and

The inverted index creating module 1202 is configured to create an index relationship between the keywords and the video file information including the keywords to thereby create an inverted index file of the video files.

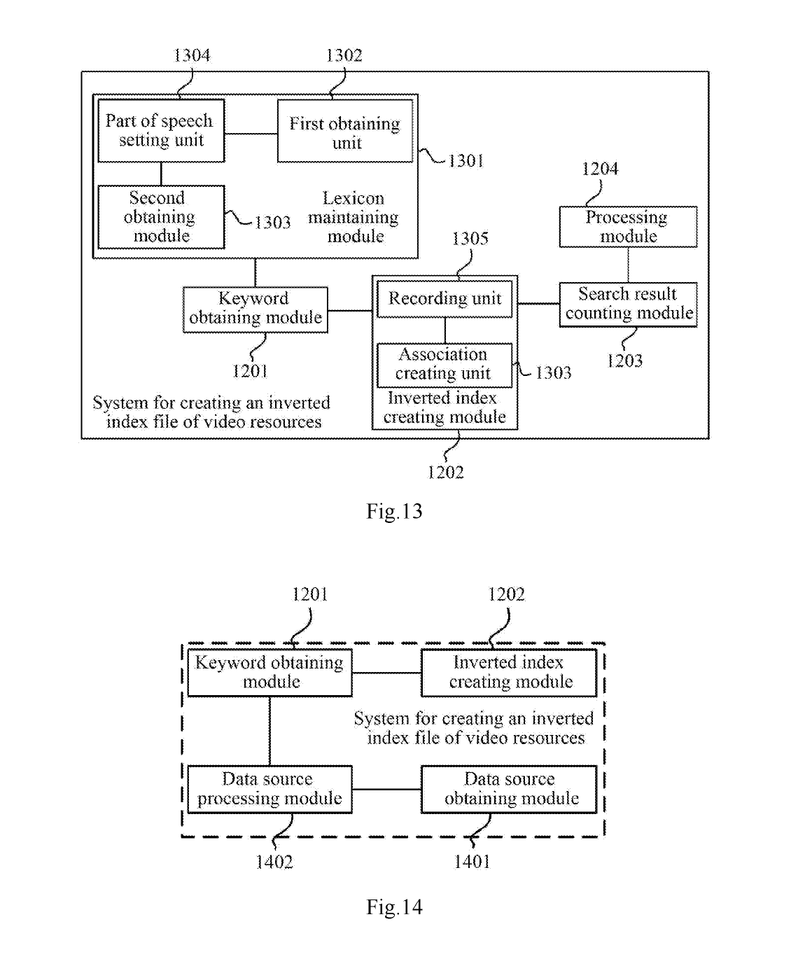

FIG. 13 is another system for creating an inverted index file of video resources according to an embodiment of the disclosure, where the system further includes a lexicon maintaining module 1301 in addition to the structure of FIG. 12, where:

The lexicon maintaining module 1301 is configured to obtain word information of dictionaries as base part of a video resource lexicon, to obtain and add word information of the video resources to primary part of the video resource lexicon, and to obtain and add word information searched by a user to supplementary part of the video resource lexicon, where the lexicon includes the base part, the primary part, and the supplementary part; and

The keyword obtaining module 1201 is configured to obtain the keywords by performing word segmentation process on the video file information according to the lexicon in the preset segmentation scheme.

Furthermore the lexicon maintaining module 1301 can include a first obtaining unit 1302, a second obtaining unit 1303, and a part of speech setting unit 1304, where:

The first obtaining unit 1302 is configured to obtain word information of video resources stored in a preset video resource library, and to add the obtained word information of the video resources to the lexicon as the primary part of the lexicon;

The second obtaining unit 1303 is configured to obtain word information input by searching users, and if there is no word information, in the current video resource lexicon, corresponding to the word information input by the users, to add the word information input by the users to the lexicon as the supplementary part of the lexicon; and

The part of speech setting unit 1304 is configured to set part of speech information of the word information of the video resources according to sources of the video resources, where the part of speech information includes general words or albums or user uploaded videos, where the different parts of the lexicon include words with corresponding part of speech information.

Furthermore the inverted index creating module 1202 includes a recording unit 1305 and an association creating unit 1306, where:

The recording unit 1305 is configured to record and store index information of the keywords, where the index information includes identifier information of video files including the keywords, information about positions where the keywords occur, and information about frequencies that the keywords occur; and

The association creating unit 1306 is configured to create the association between the keywords and their index information.

Additionally the system further includes a search result counting module 1203 and a processing module 1204, where the search result counting module 1203 is configured to count search results obtained from the inverted index file; and the processing module 1204 is configured to adjust the keywords with a search frequency above a preset threshold to the head of the inverted index file.

In another embodiment, FIG. 14 is a further system for creating an inverted index file of video resources according to an embodiment of the disclosure, where the system further includes a data source obtaining module 1401 and a data source processing module 1402 in addition to the structure of FIG. 12, where:

The data source obtaining module 1401 is configured to obtain data sources of the video resource data in various dimensions;

The data source processing module 1402 is configured to translate the data sources into a data model created in a predetermined data structure, and to store the data model as a materialized view; and

The keyword obtaining module 1201 is configured to segment the materialized view file into the keywords in the preset segmentation scheme.

Furthermore the data source obtaining module includes a first processing unit and a second processing unit (not illustrated), where the first processing unit is configured to set base data in the video data in a length-fixed structure, and to store the base data in rows; and the second processing unit is configured to set extended data in the video data in a length-variable structure, and to store the extended data in columns.

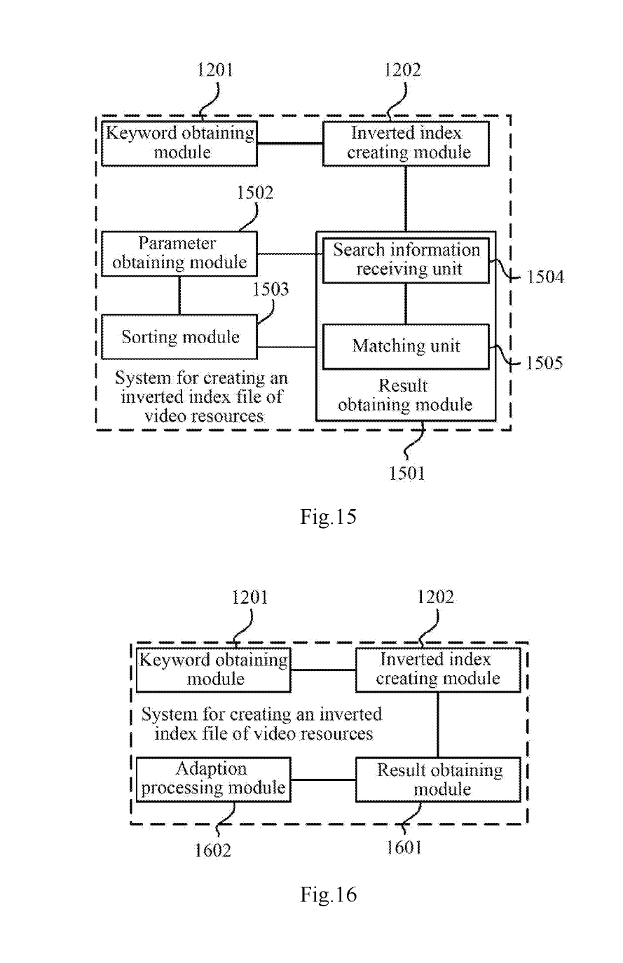

In a further embodiment, FIG. 15 is a further system for creating an inverted index file of video resources according to an embodiment of the disclosure, where the system further includes a result obtaining module 1501, a parameter obtaining module 1502 and a sorting module 1503 in addition to the structure of FIG. 12; and of course, the system can further include these three modules in addition to the structure of FIG. 14, although this embodiment will be illustrated and described only with reference to FIG. 12, where:

The result obtaining module 1501 is configured to obtain a result set of inverted indexing for the video files from the inverted index file;

The parameter obtaining module 1502 is configured to provide sort parameter information, and to receive a user selected sort parameter; and

The sorting module 1503 is configured to sort the result set of inverted indexing according to the received sort parameter.

For example, the sort parameter information includes video types, show time, play duration, and video file related information.

Furthermore the result obtaining module 1501 can include a search information receiving unit 1504 and a matching unit 1505, where:

The search information receiving unit 1504 is configured to receive search information for video data; and

The matching unit 1505 is configured to match the search information within the inverted index file, and to obtain the result set of inverted indexing from the data in the inverted index file, matching with the search information.

In a further embodiment, FIG. 16 is a further system for creating an inverted index file of video resources according to an embodiment of the disclosure, where the system further includes a result obtaining module 1601 and an adaption processing module 1602 in addition to the structure of FIG. 12, where:

The result obtaining module 1601 is configured to obtain the result set of inverted indexing for the video file from the inverted index file; and

The adaption processing module 1602 is configured to adapt the result set of inverted indexing for various types of terminals under a preset adaptation rule to provide video data suitable for the various types of terminals.

For example, the various types of terminals include TV sets, mobile terminals, and computers; and the adaptation rule is set according to the following parameters of the various types of terminals: copyright, data traffic, and a platform.

Furthermore the adaption processing module 1602 is configured to create an adaptation relationship between the parameters of the terminals and the data in the result set of inverted indexing according to the types of the terminals.

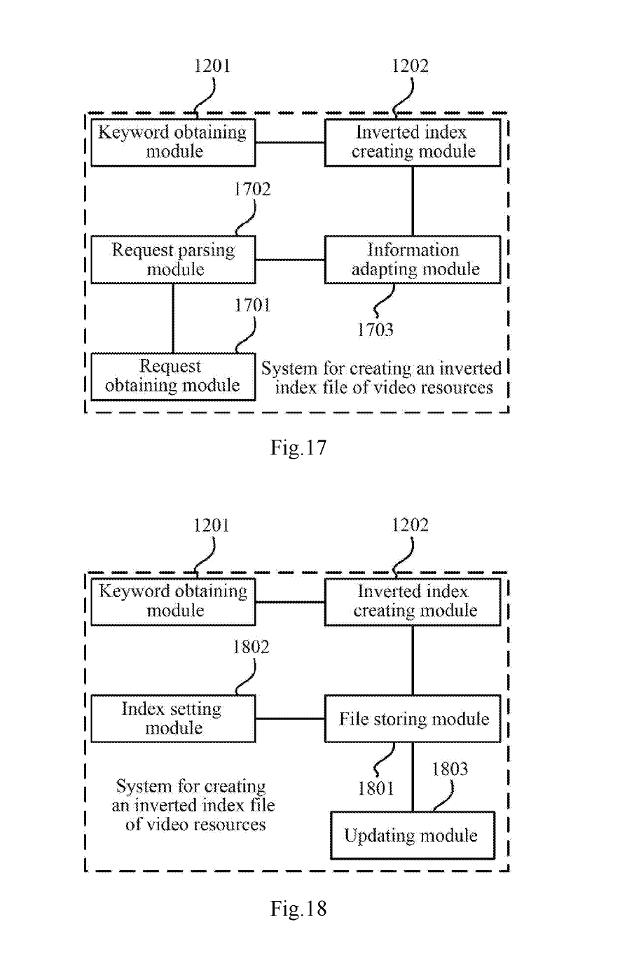

In a further embodiment, FIG. 17 is a further system for creating an inverted index file of video resources according to an embodiment of the disclosure, where the system further includes a request obtaining module 1701, a request parsing module 1702, and an information adapting unit 1703 in addition to the structure of FIG. 12, where:

The request obtaining module 1701 is configured to obtain a video data request, encoded in the HTTP protocol, input by a client;

The request parsing module 1702 is configured to parse the video data request encoded in the HTTP protocol for adaptation information carried in the video data request encoded in the HTTP protocol; and

The information adapting unit 1703 is configured to translate the adaptation information into interface parameters of a local inverted index search engine, and to invoke the local inverted index search engine to perform adaption.

Furthermore the request parsing module 1702 is configured to parse key-value pair information included in a header of the video data request encoded in the HTTP protocol by at least one of parsing a keyword, parsing a temporal range, parsing a regular expression, and parsing a prefix, for the adaptation information, where different key-value pairs carry different adaptation information.

Furthermore the request parsing module 1702 configured to parse a keyword in the key-value pair information included in the header of the video data request encoded in the HTTP protocol is configured to match absolutely or fuzzily the key-value pair information included in the video data request encoded in the HTTP protocol with preset keywords.

In a further embodiment, FIG. 18 is a further system for creating an inverted index file of video resources according to an embodiment of the disclosure, where the system further includes a file storing module 1801 and an index setting module 1802 in addition to the structure of FIG. 12, where:

The file storing module 1801 is configured to provide a number of index servers, and to store the inverted index file synchronously to the index servers; and

The index setting module 1802 is configured to configure the corresponding index servers separately to provide an index service, according to access channels of end devices.

Furthermore the index setting module 1802 includes a first setting unit and a second setting unit (not illustrated), where the first setting unit is configured to configure the corresponding index servers separately to provide an index service, according to the types of the end devices; and the second setting unit is configured to configure the corresponding index servers separately to provide an index service, according to operator platforms on which the end devices operate.

Furthermore the system further includes an updating module 1803 configured to receive an updated inverted index file, and to distribute the update of the inverted index file to the index servers corresponding to the access channels of the end devices in a preset update mode.

Furthermore the system further includes an access recording module and an index managing module, where:

The access recording module is configured to record the number of access requests of the end devices; and

The index managing module is configured, if the number of access requests to the same inverted index file exceeds a preset threshold, to provide extended index servers to receive access requests of the end devices.

Still furthermore the system is located on a data node selected by a control node, where the control node manages a number of data nodes, and the control node includes: a performance recording module configured to record performance information of the respective data nodes; and a node controlling module configured to select the data node according to the performance information of the respective data nodes.

The control node further includes an acquiring module configured to acquire periodically the performance information of the respective data nodes, and the performance information includes at least one of a data processing capacity, the amount of stored data, and load information.

The node controlling module of the control node is further configured to control the selected data node to store the inverted index file, and to control another data node to back up the inverted index file.

The control node further includes: a query receiving module configured to receive a query from a client for video data; an interacting module configured to broadcast the query across the data nodes, and to receive query results returned by data nodes storing therein the inverted index file corresponding to the query; and a result sending module configured to return the query results to the client.

The foregoing disclosure is merely illustrative of the preferred embodiments of the disclosure but not intended to limit the disclosure, and any modifications, equivalents, adaptations, etc., made without departing from the spirit and scope of the disclosure shall fall into the scope of the disclosure.

1. A method for creating an inverted index file of video resources, the method comprising:
obtaining key words by performing word segmentation on video file information in a preset segmentation scheme; and
creating an index relationship between the keywords and the video file information including the keywords to create an inverted index file of the video files.

2-7. (canceled)

8. The method according to claim 1, further comprising:
counting search results obtained from the inverted index file, and adjusting the keywords with a search frequency above a preset threshold to head of the inverted index file.

9. The method according to claim 1, wherein before obtaining the keywords by performing word segmentation on the video file information in the preset segmentation scheme, the method further comprises:
obtaining data sources of the video resource data in various dimensions; and
translating the data sources into a data model created in a predetermined data structure, and storing the data model as a materialized view; and
the operation of obtaining the keywords by performing word segmentation on the video file information in the preset segmentation scheme comprises: obtaining the keywords by performing word segmentation on the materialized view file in the preset segmentation scheme.

10-13. (canceled)

14. The method according to claim 1, further comprising:
obtaining a result set of inverted indexing for the video files from the inverted index file;
providing sort parameter information, and receiving a user selected sort parameter; and
sorting the result set of inverted indexing according to the received sort parameter.

15. (canceled)

16. The method according to claim 14, wherein obtaining the result set of inverted indexing for the video files from the inverted index file comprises:
receiving search information for video data; and
matching the search information within the inverted index file, and obtaining the result set of inverted indexing according to the data in the inverted index file matching with the search information.

17-19. (canceled)

20. The method according to claim 1, wherein after the inverted index file of the video files are created, the method further comprising:
obtaining a video data request, encoded in HTTP protocol, input by a client;
parsing the video data request encoded in the HTTP protocol for adaptation information carried in the video data request encoded in the HTTP protocol; and
translating the adaptation information into interface parameters of a local inverted index search engine, and invoking the local inverted index search engine to perform adaption.

21. (canceled)

22. The method according to claim 20, wherein parsing the video data request encoded in the HTTP protocol for the adaptation information carried in the video data request encoded in the HTTP protocol comprises:
parsing key-value pair information comprised in a header of the video data request encoded in the HTTP protocol for the adaptation information by at least one of parsing a keyword, parsing a temporal range, parsing a regular expression, and parsing a prefix, wherein different key-value pairs carry different adaptation information.

23. The method according to claim 22, wherein parsing the key-value pair information comprised in the header of the video data request encoded in the HTTP protocol comprises:
matching absolutely or fuzzily the key-value pair information comprised in the video data request encoded in the HTTP protocol with preset keywords.

24-27. (canceled)

28. The method according to claim 1, wherein the video files are video data uploaded by clients; and
creating the inverted index file of the video files comprises: creating, by a data node selected by a control node, the inverted index file of the video data, wherein the control node manages a number of data nodes, and the control node records performance information of the respective data nodes; and the control node selects the data node according to the performance information of the respective data nodes.

29. (canceled)

30. The method according to claim 28, further comprising:
controlling, by the control node, the selected data node to store the inverted index file, and controlling another data node to back up the inverted index file.

31. The method according to claim 30, further comprising:
receiving, by the control node, a query from a client for video data;
broadcasting, by the control node, the query across the data nodes;
receiving, by the control node, query results returned by data nodes storing therein the inverted index file corresponding to the query; and
returning, by the control node, the query results to the client.

32. A system for creating an inverted index file of video resources, the system comprising:
a processor and a memory, wherein the memory stores one or more computer readable program codes, and the processor is configured to execute the computer readable program codes, to perform operations of:
obtaining keywords by performing word segmentation process on video file information in a preset segmentation scheme; and
creating an index relationship between the keywords and the video file information comprising the keywords to create an inverted index file of the video files.

33-35. (canceled)

36. The system according to claim 32, the processor is further configured to perform operations of:
counting search results obtained from the inverted index file; and
adjusting the keywords with a search frequency above a preset threshold to head of the inverted index file.

37. The system according to claim 32, the processor is further configured to perform operations of:
obtaining data sources of the video resource data in various dimensions; and
translating the data sources into a data model created in a predetermined data structure, and to store the data model as a materialized view; and
obtaining the keywords by performing word segmentation on the materialized view file in the preset segmentation scheme.

38. (canceled)

39. The system according to claim 32, the processor is further configured to perform operations of:
obtaining a result set of inverted indexing for the video files from the inverted index file;
providing sort parameter information, and receiving a user selected sort parameter; and
sorting the result set of inverted indexing according to the received sort parameter.

40. (canceled)

41. The system according to claim 39, wherein the operation of obtaining the result set of inverted indexing for the video files from the inverted index file comprises:
receiving search information for video data; and
matching the search information within the inverted index file, and obtaining the result set of inverted indexing from the data in the inverted index file matching with the search information.

42-44. (canceled)

45. The system according to claim 32, the processor is further configured to perform operations of:
obtaining a video data request, encoded in HTTP protocol, input by a client;
parsing the video data request encoded in the HTTP protocol for adaptation information carried in the video data request encoded in the HTTP protocol; and
translating the adaptation information into interface parameters of a local inverted index search engine, and invoking the local inverted index search engine to perform adaption.

46. The system according to claim 45, wherein the operation of parsing the video data request encoded in the HTTP protocol for the adaptation information carried in the video data request encoded in the HTTP protocol comprises:
parsing key-value pair information comprised in a header of the video data request encoded in the HTTP protocol for the adaptation information by at least one of parsing a keyword, parsing a temporal range, parsing a regular expression, and parsing a prefix, wherein different key-value pairs carry different adaptation information.

47. The system according to claim 46, wherein the operation of parsing the key-value pair information comprised in the header of the video data request encoded in the HTTP protocol comprises:
matching absolutely or fuzzily the key-value pair information comprised in the video data request encoded in the HTTP protocol with preset keywords.

48-51. (canceled)

52. The system according to claim 32, wherein the system is located on a data node selected by a control node, wherein the control node is configured to manage a number of data nodes, and to record performance information of the respective data nodes; and the control node is further configured to select the data node according to the performance information of the respective data nodes.

53. (canceled)

54. The system according to claim 52, wherein:
the control node is further configured to control the selected data node to store the inverted index file, and to control another data node to back up the inverted index file.

55. The system according to claim 52, wherein the control node is further configured:
to receive a query from a client for video data;
to broadcast the query across the data nodes, and to receive query results returned by data nodes storing therein the inverted index file corresponding to the query; and
to return the query results to the client.
